(19) United States
(12) Patent Application Publication
(10) Pub. No.: US 2009/0106094 A1
(43) Pub. Date: Apr. 23, 2009

(54) AUCTIONING AND ADVERTISEMENT PLACEMENT SYSTEM

(75) Inventors: Jonathan DeLine, Oak Ridge, NC (US); John Sterling, Sugar Land, TX (US)

Correspondence Address: NELSON MULLINS RILEY & SCARBOROUGH, LLP, 1320 MAIN STREET, 17TH FLOOR, COLUMBIA, SC, 29201, US

(73) Assignee: GILBARCO INC., Greensboro, NC (US)

(21) Appl. No.: 11/624,002

(22) Filed: Jan. 17, 2007

Related U.S. Application Data
(60) Provisional application No. 60/759,442, filed on Jan. 17, 2006.

(51) Int. Cl. G06Q 30/00

(52) U.S. Cl. 705/14

(57) ABSTRACT

A service station advertising display system that allows users locally at the service station and remotely to request, upload, purchase and bid on advertising display time for displays located in the service station environment. Displays may be located on fuel dispensers or other locations proximate to where customers interact for requesting fueling, and other services such as convenience store and quick service restaurant purchases. The invention allows users to access available advertising times for displays, and bid or participate in an auction to control the display time. The user can upload their own content to be displayed, or use advertising content and tools located on servers to create content. The system resolves any conflicts with overlaps in different requests for advertising, downloads the content to the displays to be displayed, and tracks the effectiveness of the displayed content for billing and/or other purposes.

### RELATED APPLICATION

This application claims the benefit and priority to U.S. Provisional Application No. 60/759,442, filed on Jan. 17, 2006, entitled “Auctioning and Advertisement Placement System,” which is incorporated hereby by reference in its entirety.

### FIELD OF THE INVENTION

The present invention is related to an auctioning and advertisement placement system, particularly for service station environments employing fuel dispensers having customer-oriented displays.

### BACKGROUND OF THE INVENTION

The advent of “pay at the pump” technology has created some anxiety amongst fueling environment operators, because while pass through rates for customers purchasing fuel have increased, fewer customers enter the main building of the fueling environment and purchase higher margin items, such as chips and soda. The loss of revenue from the higher margin items, in many cases, more than offsets the increased revenue from the increased pass through rates for customers purchasing fuel.

One of the first efforts to address this loss of revenue was the increased presence of advertising materials proximate the fuel dispensers. Initially, such advertising materials took the place of simple signage on the side of, or on top of, the fuel dispenser. The signage would advertise special promotions or advertise items which the operator of the fueling environment desired to sell. Slightly more sophisticated efforts took the form of adding a scrolling bar of text through a light emitting diode (LED) display on the fuel dispenser. The text that scrolled across the display could be modified by the operator of the fueling environment as needed. However, the limits of the display prevented truly compelling advertisements from being presented to customers.

“Pay-at-the-pump” technology, such as the Gilbarco® CRIND®-equipped fuel dispensers, also introduced additional displays on the fuel dispenser that were used to provide instructions to the customer. These displays have been co-opted to present advertisements to customers. The most ubiquitous of such advertisements is a solicitation to purchase a car wash as part of the fueling transaction. The most recent generation of fuel dispensers, including the Gilbarco® Monochrome™ and Infoscreen® displays, has additional, larger displays that function independently of the fueling transaction instructions. The displays are typically larger and of better quality such that they can support relatively high grade graphics, full motion video, and the like. An example of such a display is found on the Encore® and Eclipse® fuel dispensers sold by Gilbarco Inc. of 7300 W. Friendly Road, Greensboro, N.C. 27410.

Having established that the displays of the fuel dispensers are capable of supporting advertisements that are much more robust than the relatively crude signage of the early advertising efforts, there is an opportunity for the operator of the fueling environment to generate additional revenue above and beyond that generated by sales induced by the earlier advertisements.

### SUMMARY OF THE INVENTION

The opportunity for additional revenue comes from the sale of advertising time on the fuel dispenser displays. Much as a television or radio station allows air time to be used by advertisers for commercials, the operator of the fueling environment has, at her disposal, the ability to become a publisher complete with the ancillary revenues associated with the sale of advertisements within the fueling environment. Furthermore, the displays of the fuel dispensers do not rely on broadcast spectrum controlled by the Federal Communications Commission (FCC) and has more leeway in what may be presented as an advertisements.

The present invention attempts to maximize the revenue from the sale of advertisements on the fuel dispenser displays by auctioning the right to present advertisements on the fuel dispenser displays. There are many permutations on how the auction can be conducted and how the advertisements are then delivered to the fuel dispenser displays. The following paragraphs present many of these permutations as separate embodiments, but it should be appreciated that the permutations are not always mutually exclusive, and an embodiment of the present invention may include one or more of the embodiments discussed below, as needed or desired.

In an exemplary embodiment, each fueling environment operates its own auctions to sell its available display time. In a second embodiment, groups of fueling environments pool display time and sell the right to advertise on each display of the group through a single transaction. While the first embodiment allows advertisers to customize how they target their advertisements, the second option lowers transaction costs by reducing the number of transactions the vendor incurs to advertise on many displays. The groups may be defined by any number of criteria including like minded fueling environment operators, fueling environments controlled by a single brand, fueling environments controlled by a single corporation, or the like.

In another exemplary embodiment, the auction is conducted through a computer system. While it is possible that only a single computer is used for the auction, a better solution is the use of multiple computers capable of communicating with one another over a communications medium, such as the internet. In a particularly contemplated embodiment, the auction is conducted through an auction server, via its website, which can be accessed by the bidders' web browsers. Bidders may establish long-standing accounts on the auction server or may create a new account for each auction, as needed or desired.

In another exemplary embodiment, the auctions allow the bidders to bid against one another based on differing criteria, such as time of day, temperature, other weather conditions, demographic information known about the customer, traffic patterns, zip code, past purchases and buying habits of the customer, past success with the customer of a similar advertisement (as evidenced by a sale being attributed to advertising to that customer), or the like. In essence, these criteria allow the bidders to control how and to whom the advertisements are provided. This control allows the creation of carefully targeted advertising campaigns designed to maximize revenue generated by the advertising campaign.

In another exemplary embodiment, the creation of the advertisements may be done through appropriate computer software associated with the auction server. In this embodiment, the winning bidder accesses the software and creates the advertisements using the tools provided by the auctioneer. This embodiment helps guarantee that the advertisements comply with and are compatible with the system requirements of the fuel dispenser displays. Alternatively, the auction server may be adapted to accept full or partial advertisements from the winning bidder. These full or partial advertisements are created by the winning bidder using whatever tools the winning bidder desires. This embodiment allows more customization on the part of the winning bidder, but risks that the winning bidder may try to use an advertisement that is not compatible with or inappropriate for the system requirements of the fuel dispenser displays.

In another exemplary embodiment, the advertisements are distributed to site controllers of the fueling environments through a communication medium, such as the internet. The site controller may then distribute the advertisements to the fuel dispensers as needed or desired. Alternatively, if the fuel dispensers are internet capable, the advertisements may be distributed directly to the control systems associated with the individual fuel dispensers. Another option, which increases the security of the advertisement at the expense of being more cumbersome in terms of implementation, is distributing the advertisements through a tangible item such as floppy disc, a compact disc, an optical disc, or the like. The tangible item may be delivered by the mail, by an authorized service contractor, or the like. While the risk of the advertisement being intercepted in an act of industrial espionage is potentially reduced, the distribution scheme is more manpower intensive and requires additional non-automated steps which may not be desirable in some circumstances.

Once the advertisements are available at the fuel dispenser, a control system monitors for the occurrence of the criteria under which the advertisements are to be displayed. This control system may, in an exemplary embodiment, be the control system of the fuel dispenser. Alternatively, the control system may be the site controller for the fueling environment. As still another alternative, the control system may be located remotely from the fueling environment and could be associated with the auction server. Once the control system determines that the criteria are correct, the control system causes the fuel dispenser display to show the advertisement to the customer.

Due to the wide-ranging criteria which are capable of being used as the basis of the auction, there are potentially conflicts between winning bids. For example, if a first winning bidder purchased the right to have its advertisements presented between two and five p.m. and another winning bidder purchased the right to have its advertisements presented if the temperature was over eighty-five degrees Fahrenheit, it is possible that it could be ninety degrees at three p.m., thereby creating a potential conflict. The auction software of the present invention may have varying degrees of sophistication to resolve these potential conflicts between different criteria.

In an exemplary embodiment, the auction server predefines the auction terms such that there is no potential for conflict between winning bids. That is, the auction server defines different auctions based on one overriding criterion; sub-criteria are likewise preemptively prioritized by definition of the auction server before the bidders are ever given the opportunity to bid. In this manner, the bidders must find the auction which best fits their desired target audience and bid in that auction.

In a second embodiment, each criterion is auctioned separately. If two or more criteria occur simultaneously the highest bid still wins even though the bidders are not bidding on exactly the same criteria. For example, if bidder A bid x for the time slot of three p.m. to five p.m. and bidder B bid y for males between sixteen and twenty-five, then bidder A's advertisement is presented if x is greater than y and bidder B's advertisement is presented if y is greater than x.

Alternatively, one or more auctions can be combined to form a composite bid. Then, when there is an opportunity for advertisement presentation, a determination is made as to what criteria are satisfied by the opportunity. These criteria are reported to the decision maker who compares each bidder's composite bid to determine who is willing to pay the most for that opportunity. For example, if bidder A bid x1 for the time slot of three to five PM and bidder B bid y1 for the same time slot; bidder A bid x2 for temperatures over eighty degrees F. and bidder B bid y2 for the same temperature range; and bidder A bid x3 for men between sixteen and twenty-five and bidder B bid y3 for the same demographic, when a twenty year old male buys gas at four p.m. on a ninety degree Fahrenheit day, the decision maker compares x1+x2+x3 to y1+y2+y3. If x1+x2+x3 is greater than y1+y2+y3, then bidder A's advertisement is presented and vice versa.

In a third embodiment, the bidders may provide an indication of a conditional bid escalation in the event of a conflict. This situation is appropriate for the situation where criteria are auctioned separately. The bid escalation may have differing degrees of escalation. For example, the bid could state that the bidder is willing to pay x1 for a the time slot between three and five PM, but x2 if x1 is a losing bid for that time slot on a day over eight-five degrees F., x3 if x1 is a losing bid that time slot coupled with a male between sixteen and twenty-five, and x4 if x1 is a losing bid for that time slot coupled with a male between sixteen and twenty-five on a day over eighty-five. As is readily apparent, the number of permutations is limited only by the number of criteria.

Because some embodiments have conditional bids, it is possible that the bidder pays only when the bid is a winning bid and an advertisement is presented. This arrangement may make the bidders more willing to use the auction system if they know that they are only paying for advertisements that are actually presented and not merely for winning a bid on a particular criterion. Alternatively, the opportunity to have an advertisement presented may justify that merely winning a bid on a particular criterion incurs the obligation to pay.

As another permutation, the bidders may put a cap on the number of times the advertisement is presented. This cap may be made so as to prevent over saturation of the market with a particular advertisement. Alternatively, if the obligation to pay only vests when the advertisement is actually presented, then the cap may be an effective cost control mechanism. For example, the bidder may bid y for each advertisement presented, but will not pay more than 300y for each unit of time. Once the budget is exhausted, the bid is removed from the system and the losing bidders may present their advertisements according to the terms of their bids. This arrangement also provides bidders with the opportunity to create graduated bids. For example, the bidder could be willing to pay y1 for the first three hundred presentations of the advertisements and y2 for the next three hundred and y3 for the next three hundred.

It is also possible to track the success of the advertisements and report this success to the bidders so the bidders may judge how effective a particular advertising campaign is. Tracking may be effectuated in a number of ways. One option is to credit any sale of the advertised product within a certain time of the advertisement presentation to the advertisement. For example, if a soda advertisement is presented and someone buys that soda within five minutes of the presentation of the advertisement, then the system infers that the sale was generated by the advertisement. Another option is to present the customer with a coupon which may be redeemed in conjunction with the advertisement. The number of coupons redeemed may be compared to the number of advertisements presented to determine effectiveness. A sub permutation of this option is inquiring whether the customer would like a coupon based on the advertisement. Still another option is to link the customer's fuel purchase to the secondary purchase. Such tracking may be effectuated through the use of the same credit/debit card in both purchases, the use of a loyalty card, surveillance devices, or the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of a service station employing fuel dispensers and an advertisement auction and placement architecture and networking system;

FIG. 2 is an illustration of a remote advertising server and its access to databases, a network, and user terminals for accessing, controlling, and receiving advertising and content delivery and responses to and from the service station environment;

FIG. 3 is an illustration of an exemplary fuel dispenser;

FIG. 4 is a flow chart illustration of an advertisement auction and placement system using a local advertisement server;

FIG. 5 is a flowchart illustration of an auctioning and advertisement placement system employing an off-site advertisement server;

FIG. 6 is a flow chart illustration of a conflict management system for advertisements requiring the same time and/or criteria for display on an advertising server;

FIG. 7 is a flow chart illustration of an advertising response and tracking system according to one embodiment of the invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is an auctioning and advertising placement system. Users wishing to place advertisements on displays on a fuel dispenser or in a service station environment access an advertising server for placement of advertising. The advertising server executes a bidding or auctioning system that allows the user to bid on advertising according to time or other specified criteria. In this manner, the user can direct its advertising according to the desired criteria for greater effectiveness in reaching customers in a targeted fashion. The user also interacts with the advertising server to upload their content for display. Thereafter, the advertising server determines which users advertising is to be displayed at particular displays accessible on a network. The advertising server will then download the advertising content to displays on the fuel dispenser and/or in the service station area for eventual display according to the predefined time and/or other criteria.

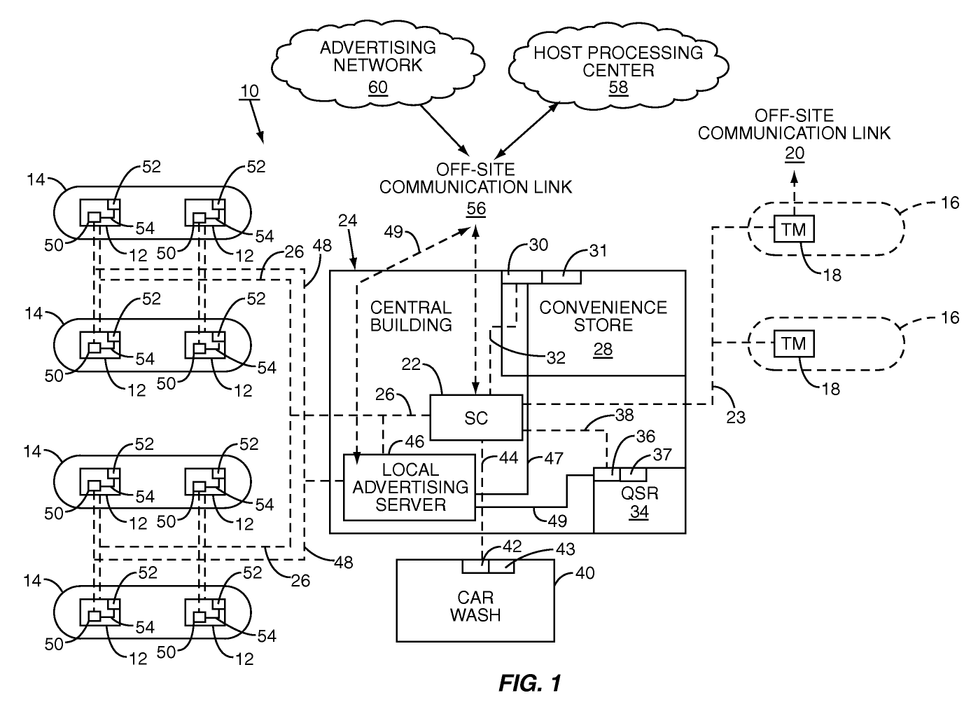

FIG. 1 illustrates an architectural illustration of a service station employing fuel dispensers that is the environment for the present invention. A communication architecture for providing advertising servers and user access to same for requesting and uploading content to be advertised to displays of interest is provided. FIG. 1 illustrates a service station environment labeled as item 10 generally. The service station 10 is comprised of one or more fuel dispensers 12 that are arranged on raised islands 14. Fuel dispensers 12 receive fuel from fuel storage tanks 16 via fuel piping conduit (not shown). Tank monitors 18 are typically provided to monitor tank conditions and inventory levels within the fuel storage tanks 16. The tank monitors 18 may be communicatively coupled via off-site communication link 20 to an off-site system for reporting, tracking, and monitoring, among other reasons. The tank monitors 18 may also be communicatively coupled to a site controller 22 via communication line 23. In this manner, as is well known, metered fuel dispensed at the fuel dispensers 12 can be reconciled, via the site controller 22, with tank levels monitored by the tank monitors 18.

The site controller 22 is typically provided within a central building 24. The site controller 22 is also communicatively coupled via wiring bus or communication network 26 to each of the fuel dispensers 12 to control the operations of the fuel dispensers 12. The site controller 22 also communicates and receives payment and other transaction processing initiated by customers requesting a dispensing transaction at the fuel dispensers 12, such as the use of credit or debit cards for example, as is well known. Examples of site controllers 12 are the Gilbarco® G-Site® and Passport® point-of-sale systems.

The central building 24 may also encompass a convenient store 28. The convenient store 28 may employ one or more computer systems or point-of-sale systems 30, which are communicatively coupled to the site controller 22. In this manner, orders placed at fuel dispensers 12 can be communicatively coupled to the convenient store 28 via site controller 22, when the fuel dispensers 12 are adapted to sell other items of interest in addition to fuel. The point-of-sale system 30 controls operations and/or ordering processing for sales and other functions in the convenience store 28. A display 31 may also be associated with the point-of-sale system 30 for user advertisements and information to be displayed to customers.

The central building 24 may also employ a quick service restaurant 34 which employs a computer system or point-of-sale system 36 coupled to the site controller 22 via communication line 38. Customers at the fuel dispensers 12 may place orders for food from the quick service restaurant 34, which are communicated via the site controller 22 to the quick service restaurant 34. The point-of-sale system 36 receives the requests for orders from the site controller 22 and/or fuel dispensers 12 and controls operations and/or ordering processing for sales and other functions in the quick service restaurant 28. A display 37 may also be associated with the point-of-sale system 36 for user advertisements and information to be displayed to customers.

A car wash 40 may also be provided and controlled by a car wash controller 42, which is communicatively coupled to the site controller 22 via communication line 44. Customers desiring a car wash can drive their car and interface directly with the car wash controller 42 for the transaction, or purchase a car wash at the fuel dispensers 12, or purchase a car was from the operation of the convenience store 28. In response, the site controller 22 communicates the car wash request from the fuel dispenser 12 to the car wash controller 42, which then returns a code back to the fuel dispenser 12. The code is given to the customer via a receipt or other means. The customer can then enter the code via the car wash controller 42 to receive the car wash. A display 43 may also be associated with the car wash controller 42 for user advertisements and information to be displayed to customers.

According to the present invention, a local advertising server 46 employing a computer or other microprocessor based system may be provided that is resident the service station 10, typically within the central building 24. The local advertising server 46 may be communicatively coupled directly to the site controller 22, the communication network 26 that is used to couple the site controller 22 to the fuel dispensers 12, the convenient store point-of sale-system 30 via communication line 47, and/or to the quick service restaurant point-of-sale system 36 via communication line 49. In this manner, each of these control systems 12, 22, 30, 36 previously referenced can interface with the local advertising server 46 to provide for advertisement and content requests and information, as well as receive content for display. The functionality will be described throughout the remainder of this application. The local advertising server 46 may also be coupled to the fuel dispensers 12 via its own communication bus or wiring loop 48 in the event that the local advertising server 46 is not communicatively compatible with the communication network 26.

Each fuel dispenser 12 comprises a control system 50 which controls various functionalities of the fuel dispensers 12. The control system 50 is typically interfaced with the site controller 22 on the communication network 26. In this manner, the site controller 22 can authorize fuel dispensing transactions to occur via communication to control system 50, which in turn activates the fuel dispenser 12 for dispensing.

In the present invention, the control system 50 is also communicatively coupled to a display 52 via display communication line 54. In this manner, the control system 50 can cause the display 52 to display instructions and other information to customers during the fuel dispensing transaction. This system is employed by Gilbarco Inc. as the InfoScreen® or InfoScreen® System. In the context of the present invention, the local advertising server 46 can download content via wiring loop 48 to the control system 50, which can in turn display such content on the displays 52, according to the prescribed rules and instructions that accompany the content. In this manner, a customer or user can access the local advertising server 46 to control advertising to be displayed at the fuel dispensers 12. This interface into the local advertising server 46 may be via a direct coupling or via the site controller 22, quick service restaurant 34 point-of-sale system 36, and/or convenient store 28 point-of-sale system 30. Likewise, the quick service restaurant 34, convenient store 28, or other areas within the central building 24 may also contain displays which the local advertising server 46 can communicate with like that of the displays 52 for displaying various content in these areas for advertising purposes.

The central building 24 is communicatively coupled to outside systems via an off-site communication link 56 that is coupled to the site controller 22. One reason for this off-site communication link 56 is for credit and debit card processing between the site controller 22 in interaction with a host processing system 58, as is well known. In addition, this off-site communication link 56 may be used to allow the site controller 22 to communicate with a remote advertising server 62 located remotely over an advertising network 60, as will be described later in this application. Further the local advertising server 46 may be able to communicatively couple over the advertising network 60 via communication through the site controller 22 as an intermediary, or directly via a direct link to the off-site communication link 56, as is shown in FIG. 1.

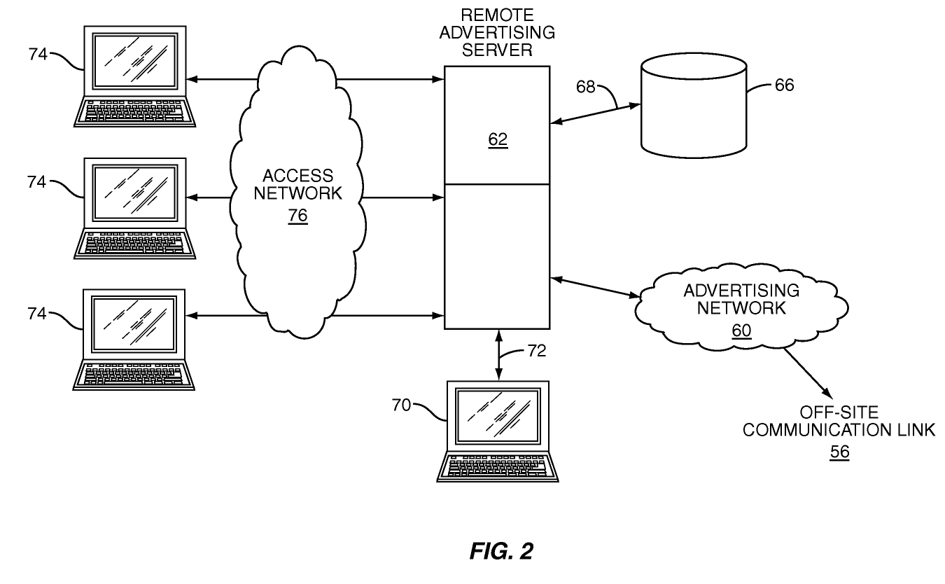

The remote advertising server 62 contains functionality similar to that of the local advertising server 46, but is able to communicate with a plurality of service stations 10 for greater access and control of content to be displayed on fuel dispensers 12 within the service stations 10. The remote advertising server 62 may be any type of computer system, which typically has access to a database 66 via communication link 68, as illustrated in FIG. 2. The database 66 may contain advertising content or other display rules and instructions. The remote advertising server 62 is directly accessible by a user at a terminal 70 via communication link 72. In this manner, the user can access the remote advertising server 62 for bidding, controlling, and uploading content to be sent out over the advertising network, and eventually to the service stations 10 for display, as will be described below. In addition to providing direct access to the remote advertising server 62 via terminal 70, access may also be obtained remotely by remote terminal 74 via an access network 76. The access network 76 may be a telephone line, dedicated network connection, and/or the Internet. The terminal 74 may execute a web browser or other program having a user interface to access and manage communications with the remote advertising server 62. Further, the advertising network 60 and the host processing system 58 may be coupled to the site controller 22 via off-site communication link 56 and to the remote advertising server 62 via similar connections.

In summary, FIGS. 1 and 2 illustrate a service station 10 and related communication architecture by which the remote advertising server 62 and the local advertising server 46 can be accessed and controlled to place and distribute advertising content to be displayed on displays within the service station 10 as desired, and in accordance to specific systems described below.

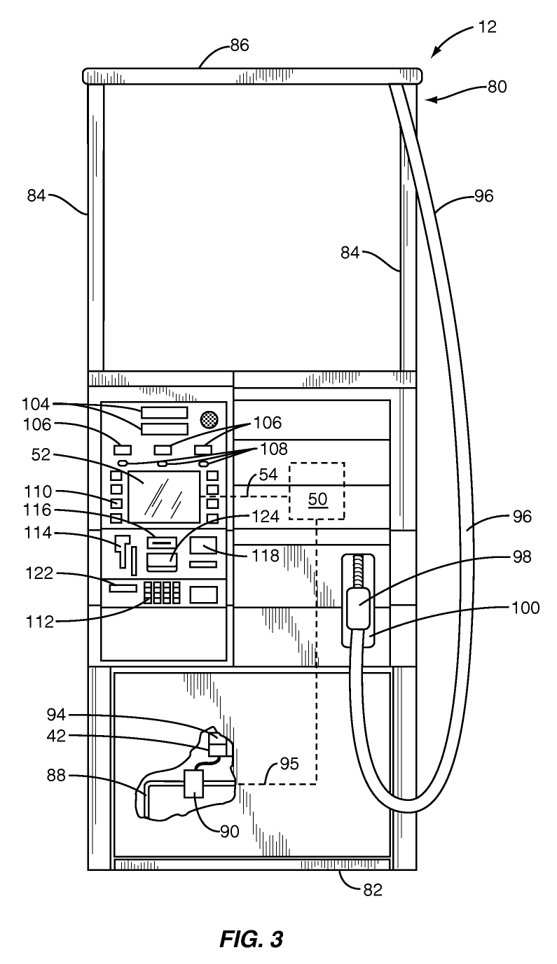

FIG. 3 illustrates an example of the fuel dispenser 12 according to one embodiment of the invention to more fully illustrate the display 52 in which content uploaded to the advertising server 46, 62 may be displayed to a customer. The fuel dispensers 12 include a fuel supply line 88, which is typically coupled to a fuel meter 90 and electrically coupled to a pulser 92 and counter 94 to measure fuel dispensed. Fuel is then transported to a hose 96 for eventual delivery to a customer's vehicle via nozzle 98. The nozzle 98 is placed in a nozzle housing 100 in the fuel dispenser 12 when not in use. The counter 94 is communicatively coupled to the control system 50 via communication line 95 so that the control system 50 can control and display the total amount of fuel dispensed and the price for such fuel via transaction displays 104. The fuel dispenser 12 is contained in housing 80, which typically includes sides 84, a canopy 86, and a base 82.

The fuel dispenser 12 illustrated in FIG. 3 is a multi-product dispenser, meaning that more than one grade of fuel can be dispensed through the hose 96 to the customer's vehicle. In this manner, different pricing is provided for each grade of fuel via price per unit displays 106. In the example illustrated in FIG. 2, three grades of fuel are possible, and thus three price per unit displays 106 are illustrated. Octane selection buttons 108 may be provided to allow the customer to select the grade of fuel desired to be dispensed.

The display 52 illustrated in FIG. 1 allows the customer to receive instructions and other information while dispensing fuel, as well as make choices for prompted selections. The customer may enter choices via soft keys 110 that are located along the left and right of the display 52. If the customer desires to make a particular choice, the customer selects the soft key 110 proximate the choice desired. The customer may also enter choices in response to prompts via a keypad 112. The customer can present payment for fuel at the fuel dispenser 12 via card reader 114, cash acceptor 116 or bar code scanner 118. In this manner, this payment data is communicated to the site controller 22 via the communication network 26 for payment processing. The site controller 22 may communicate with the host processing system 58 to process transaction information, as previously described. The fuel dispenser 12 may also contain a receipt printer 122 to issue paper receipts to the customer for fuel dispensing transactions.

As part of the present invention, an auctioning system is provided to allow multiple users to bid or purchase advertising or content. The user may select its request for display of advertising content based on available times and/or other criteria. For instance, the display 52 of the fuel dispenser 12 may have advertising availability on Monday through Friday from 2:00 p.m. to 4:00 p.m. The user may alternatively bid on, or purchase display of their advertising based, on when certain criteria occur which is not time based. For example, the advertising request from the user may trigger only when the service station 10 encounters certain weather conditions, use of a particular type of payment, whether the user selects a car wash or other services at the fuel dispenser 12, traffic patterns, demographic information known about the customer, zip code, past purchases and buying habits of the customer, past success with the customer with similar advertisements, or the like.

### Content Purchase/Bidding System

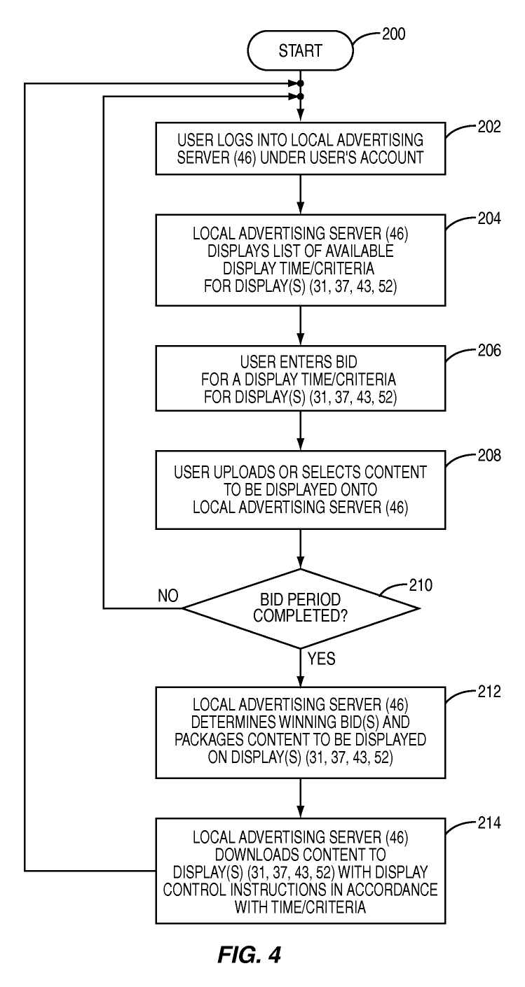

One embodiment by which users can request and purchase advertising locally at each service station 10 is illustrated in the flow chart of FIG. 4. The process starts (step 200) and the user logs into the local advertising server 46 under the user's account (step 202). If the user is logging in to the local advertising server 46 for the first time, the local advertising server 46 will prompt the user to establish a new account with a user name and password, as is typical. The local advertising server 46 may also request the user to enter payment data so that the user can be automatically charged for any requested and/or displayed content. Payment may take the form of a credit or debit card or other type of invoicing or payment systems.

Once the user logs in to the local advertising server 46, the local advertising server 46 displays a list of available display times or other criteria for displaying the user's content on displays 31, 37, 43, 52 (step 204). The user then enters a purchase request or bid for display of their content on displays 31, 37, 43, 52 according to the desired time or other criteria (step 206). The system may employ an auction or bidding system so that multiple users can request advertising content at the same time or based on the same criteria, with one user being the ultimate winner. Alternatively, the local advertising server 46 may implement a “first come, first serve” type system, whereby the first user that satisfies the purchase requirements for advertising availability will have their content displayed as requested.

Next, after the user enters their bid or request for advertising, the user is then prompted to provide the advertising content to be displayed by the local advertising server 46 (step 208). The user may upload their own electronic files or content to be displayed, or the user may select from predefined advertising content located on the local advertising server 46. The customer may also upload their advertisements through a tangible item, such as floppy disc, a compact disc, an optical disc, or the like. The tangible item may be loaded into a terminal coupled to the local advertising server 46, or delivered by the mail, by an authorized service contractor, or the like, and uploaded by the station operator.

Additionally, local advertising server 46 may includes tools or services that allow the user to create their content by accessing local advertising server 46 as desired. This allows for more customization on the part of the user, but risks that the user as a winning bidder or requester may try to use an advertisement that is not compatible with the system requirements of the displays 31, 37, 43, 52. Further, another option that increases the security of the advertisement, at the expense of being more cumbersome, is distributing the advertisements through a tangible item, such as a floppy disk, compact disk, or other like device. After the user submits a bid for placement of advertising, the user would then send this tangible medium to an operator of the local advertising server 46. If accepted, the content would then be uploaded to the local advertising server 46 manually. However, such a distribution scheme is more manpower intensive and requires additional non-automated steps, which may not be desirable in some circumstances.

Next, the local advertising server 46 determines if the bid period is completed for the requested advertising time and/or other criteria in the case of the system being an auctioning or bidding type system (decision 210). If the auction or bidding period is not completed, the local advertising server 46 continues to receive user bids by repeating steps 202 through 208 from other users until the auction or bidding period for the requested criteria or display is completed. If the system is not an auction or bidding system, decision 210 is not performed, and the system skips to step 212.

Once the local advertising server 46 determines the winning bid and/or when the user requests the content to be displayed and all other requirements are met in the form of a non-bidding or auction type system, the local advertising server 46 then packages the content to be displayed on one or more of the displays 31, 37, 43, 52 as selected or requested by the user (step 212). The local advertising server 46 then downloads the content to the displays 31, 37, 43, 52 with display control instructions in accordance with the time and/or criteria selected (step 214). Thereafter, the local advertising server 46 repeats this process by returning back to step 202. This is because now that the content with control instructions has been downloaded to the displays 31, 37, 43, 52, the displays can now independently display advertising content according to the time and/or criteria selected without further interaction with the local advertising server 46. The local advertising server 46 will then continue to download additional content to display at different times or based on other criteria, and will manage any conflicts or overlaps. The local advertising server 46 may also overwrite over previous content having the same time and/or criteria as new content depending on the rules of local advertising server 46. The local advertising server 46 may only allow the user to purchase content for a limited period of time or based on only a certain number of criteria or trigger events occurring.

In addition to allowing users to request and purchase or bid on content to be displayed locally at the service station 10 via interaction with the local advertising server 46, the present invention also allows users to remotely bid or purchase advertising time when not on site at the service station 10. This also allows users to bid or request display of content based on the same or different criteria at multiple service stations 10 rather than at a single service station 10. Some service stations 10 may pool their available display time and sell the right to advertise on their displays 31, 37, 43, 52 through a single transaction. This option lowers the transaction cost by reducing the number of transactions that vendors incur to advertise on many displays 31, 37, 43, 52. The groups that may be defined by any number of criteria include like-minded service station 10 operators, service stations 10 controlled by a single brand, service stations 10 controlled by a single corporation, or the like.

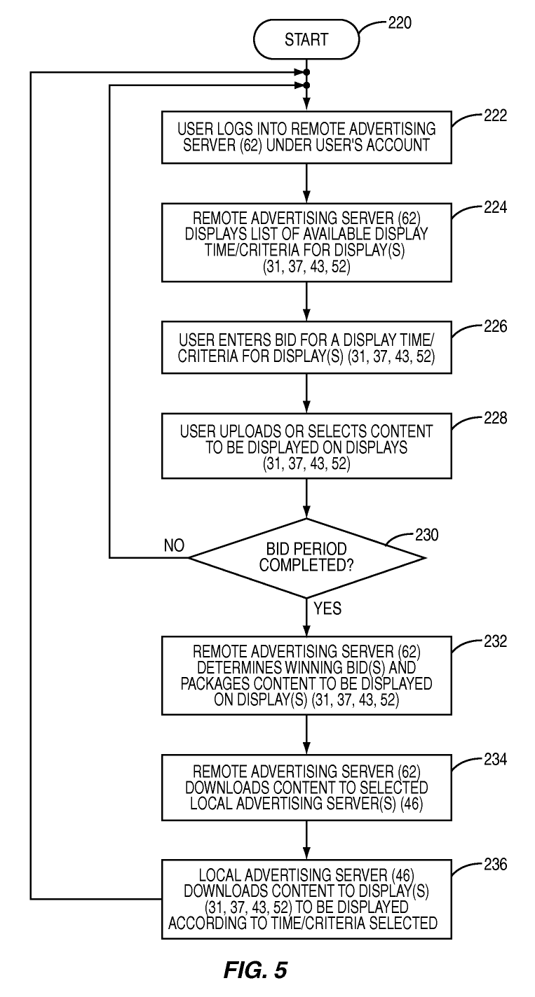

FIG. 5 illustrates a flow chart diagram that is an exemplary embodiment of the system to provide advertising content from the remote advertising server 62. The process starts (step 220), and the user logs into the remote advertising server 62 under the user's account (step 222). The remote advertising server 62 may already have an established account for the user, or the user may have to first establish a new account when logging into the remote advertising server 62.

Next, the remote advertising server 62 displays a list of available display times and/or other criteria for the displays that are located at service stations 10 within its communicative network via advertising network 60. These displays may include the displays 52, and/or other displays 31, 37, 43 at the service station 10. In this manner, the user accessing the remote advertising server 62 can request or bid on display time at any number of service stations 10 and any number of displays 31, 37, 43, 52 within such service stations 10 depending on their desires. The user typically logs into the remote advertising server 62 via access using the remote terminal 74 over the access network 76, which would typically be the Internet.

The user then bids or requests purchase of advertisements based on display time and/or other criteria for the displays 31, 37, 43, 52 (step 226). Thereafter, if the request for purchase or bid is accepted by the remote advertising server 62, the user can then upload or select the content to be displayed on the local advertising server 46. Again, the user may upload their own specific content to the remote advertising server 62 which would then be downloaded to the local advertising server 46 of the service stations 10 affected, or, the user may access tools or other already established content on the remote advertising server 62 to create their advertisements. Again, the user may also upload their advertisements through a tangible item, such as floppy disc, a compact disc, an optical disc, or the like. The tangible item may be loaded into the terminal 70, 74 coupled to the remote advertising server 62, or delivered by the mail, by an authorized service contractor, or the like, and uploaded by the remote advertising server 62 operator.

If the system is a bidding type system, the remote advertising server 62 will then determine if the bid period is completed for the particular advertising time and/or other criteria selected by the user (decision 230). If not, the remote advertising server 62 continues to perform steps 222 through 228 until the bidding period is completed for the requested display time and/or other criteria for advertisements by the user. If the system is one that is simply allowing the user to purchase advertising time without participating in an auctioning or bidding type system, decision 230 is not performed, and the system goes straight to step 232.

Next, the remote advertising server 62 determines the winning bid and/or the request for purchase of content based on the specified time and/or other criteria to be displayed on displays 31, 37, 43, 52 within the service station 10. Thereafter, the remote advertising server 62 downloads the content selected to be displayed to only those local advertising servers 46 located at service stations 10 which have been selected by the user for eventual display on the displays 31, 37, 43, 52 (step 234).

After the local advertising server 46 receives the content to be displayed at specified times and/or other criteria from the remote advertising server 62 via the advertising network 60 and off-site communication link 56, the local advertising server 46 then downloads the content to the displays 31, 37, 43, 52 selected, so that the content can be displayed according to the time and/or other criteria selected.

The access to the remote advertising server 62 will typically be via a web browser application using Internet communications. The remote advertising server 62 can be configured to allow both purchase of display content, specify prices, and an auction or bidding system for other times or criteria depending on the desired configuration. For auction type systems, the remote advertising server 62 allows bidders to bid against one another based on different criteria, such as time of day, temperature, other weather conditions, demographic information known about the customer, traffic patterns, zip code, past purchases and buying habits of the customer, past success of a similar advertisement with that customer as evidenced by a sale being attributed to the advertising to that customer, or the like.

### Advertising Display Control

Once the advertisements or content are available at the displays 31, 37, 43, 52, the control system 50 within the fuel dispenser 12 monitors for the occurrence of the time or other criteria under which the advertisements are to be displayed. Alternatively, the control system may be the site controller 22 for the service station 10, rather than the individual control systems 50 within the individual fuel dispensers 12. The control system may be a separate control system located remotely from the service station 10, and could be associated with the remote advertising server 62. Once the control system 50, site controller 22, or other control system determines that the criteria match that of a requested advertising content to be displayed, the control system then causes the fuel dispenser display 52 to show the advertisement to the customer. Likewise, the other displays 31, 37, 43 may also be controlled in the same manner.

### Conflict Management

Potential conflicts between winning bids for advertisement display are possible because of the wide range of criteria that could be used during auctioning. For example, if a first winning bidder purchased the rights to have their advertisement presented between two p.m. and five p.m., and another winning bidder purchased the right to have their advertisements presented if the temperature was over eighty-five degrees F., a conflict could occur if the temperature was ninety degrees F. at three p.m. The auction software residing within the remote advertising server 62 and/or local advertising server 46 may have varying degrees of sophistication to resolve these potential conflicts between different criteria.

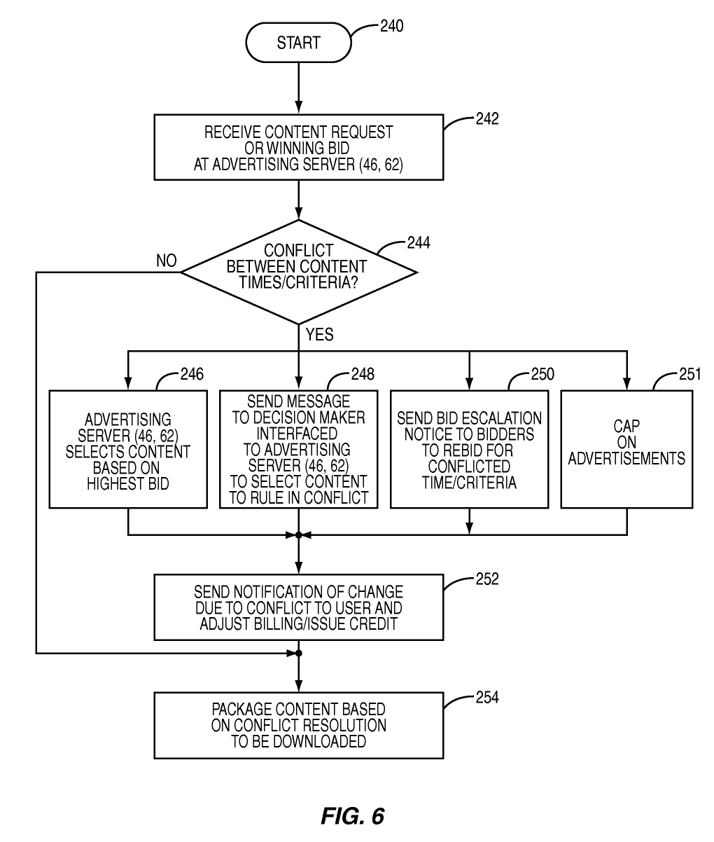

The flow chart in FIG. 6 illustrates this conflict management system in accordance with examples of the present invention. The process starts (240), and the advertising server 46, 62 receives the content request and/or winning bid, as previously described. Before the advertising server 46, 62 will package the content to be downloaded to the individual displays at which the content is to be displayed, the advertising server 46, 62 will first determine if there is a conflict or potential conflict between the times and/or other criteria selected for the advertisement based on the user's request and previously accepted requests (decision 244). If not, the content is then packaged by the advertising server 46, 62 to be downloaded to the individual control systems that control displays 31, 37, 43, 52 to be downloaded for display as previously described (step 254).

If there is a conflict determined to exist by the advertising server 46, 62 (decision 244), the advertising server 46, 62 may be configured to resolve the conflict in any number of ways. Steps 246, 248, and 252 in FIG. 6 illustrate three exemplary systems to resolve conflicts. As illustrated in step 246, the advertising server 46, 62 may choose one content request over the other based on whichever request had the highest bid in terms of payment amount.

Alternatively, the advertising server 46, 62 may not choose one advertising content from one user over another automatically, but instead send a message to a decision maker that can interface with the advertising servers 46, 62 to select the content to be preferable over other content that is in conflict (step 248). These criteria are reported to the decision maker who compares each bidder's composite bid to determine who is willing to pay the most for that opportunity. For example, if bidder A bid x1 for the time slot of three p.m. to five p.m., and bidder B bid y1 for the same time slot; bidder A bid x2 for temperatures over eighty degrees F. and bidder B bid y2 for the same temperature range; and bidder A bid x3 for men between sixteen and twenty-five, and bidder B bid y3 for the same demographic, when a twenty year old male buys gas at four p.m. on a ninety degree F. day, the decision maker compares x1+x2+x3 to y1+y2+y3. If x1+x2+x3 is greater than y1+y2+y3, then bidder A's advertisement is presented and vice versa.

Yet another method of resolving a conflict is in step 252, wherein the advertising server 46, 62 will send a bid escalation notice to users to re-bid for the conflicted time and/or criteria (step 250). This situation is appropriate where criteria are auctioned separately. The bid escalation may have differing degrees of escalation. For example, the bid could state that the bidder is willing to pay x1 for the time slot between three p.m. to five p.m., but x2 if x1 is a losing bid for that time slot on a day over eighty-five degrees F., x3 if x1 is a losing bid that time slot coupled with a male between sixteen and twenty-five, and x4 if x1 is a losing bid for that time slot coupled with a male between sixteen and twenty-five on a day over eighty-five degrees F. As is readily apparent, the number of permutations is limited only by the number of criteria.

Because some embodiments have conditional bids, it is possible that the bidder pays only when the bid is a winning bid and an advertisement is presented. This arrangement may make the bidders more willing to use the auction system if they know that they are only paying for advertisements that are actually presented and not merely for winning a bid on a particular criterion. Alternatively, the opportunity to have an advertisement presented may justify that merely winning a bid on a particular criterion incurs the obligation to pay.

As another permutation, the bidders may put a cap on the number of times the advertisement is presented as a means of conflict resolution (step 251). The cap may be made so as to prevent over saturation of the market with a particular advertisement. Alternatively, if the obligation to pay only vests when the advertisement is actually presented, then the cap may be an effective cost control mechanism. For example, the bidder may bid y for each advertisement presented, but will not pay more than 300y for each unit of time. Once the budget is exhausted, the bid is removed from the system, and the losing bidders may present their advertisements according to the terms of their bids. This arrangement also presents bidders the opportunity to create graduated bids. For example, the bidder could be willing to pay y1 for the first three hundred presentations of the advertisements, y2 for the next three hundred, and y3 for the next three hundred.

No matter what conflict resolution technique is employed by the advertising servers 46, 62, the user whose content will not be displayed due to the conflict and was not chosen in view of other conflicting content will be sent a notification of the change due to the conflict, and the user's account will be adjusted for any billing or credit issues that need to be resolved (step 252). Thereafter, the content which has been conflict resolved is downloaded to the displays 31, 37, 43, 52 to be displayed in accordance with the selected time and/or criteria (step 254).

The advertising servers 46, 62 may provide auctions, bidding, or request systems so that no conflict can occur. That is, the advertising server 46, 62 will define different options or purchase availability based on one overriding criterion and sub-criterion. Sub-criteria are likewise preemptively prioritized by the definitions in the advertising server 46, 62 before the bidders are even given the opportunity to bid. In this manner, bidders only bid on options the fit their target audiences and are known to not conflict with other criteria.

### Advertising Response Tracking

Lastly, the system of the present invention employs a tracking system to determine if the advertisements are actually displayed and/or responded to as part of the billing system. The system may be designed so that only content that is displayed is charged to the user, since the criteria prescribed for the advertisement may or may not occur. Billing may also occur based on the effectiveness of the advertisement in a number of ways. One option is to credit the advertisement with any sale of the advertised product within a certain time of the advertisement presentations. For example, if a soda is advertised, and a customer buys that soda within five minutes of the presentation of the advertisement, then the system infers that the sale was generated by the advertisement.

Another option is to present the customer with a coupon which may be redeemed in conjunction with the advertisement. The number of coupons redeemed may be compared to the number of advertisements presented to determine effectiveness. A sub permutation of this option is inquiring whether the customer would like a coupon based on the advertisement. Still another option is to link the customer's fuel purchase to a secondary purchase. Tracking may also be effectuated through the use of the same credit or debit card in both purchases, the use of a loyalty card, surveillance devices, or the like.

Another way to track the success of the advertisement is instant feedback from the consumer. Specifically, the device on which the advertisement is displayed may allow immediate feedback through a user interface. Feedback may take the form of entries provided through the user interface. For example, a series of “yes/no” questions could be asked of the customer, and the customer could respond via the keypad 112 or a touch pad of the user interface. Alternatively, the device may be equipped with one or more active devices, such as a camera and a microphone into which the customer may provide feedback. Appropriate software would capture images and/or audio from the input devices, record them into digital format, and make this captured data available to a vendor. In this manner, the vendor may more accurately identify what customers think of the advertising campaign.

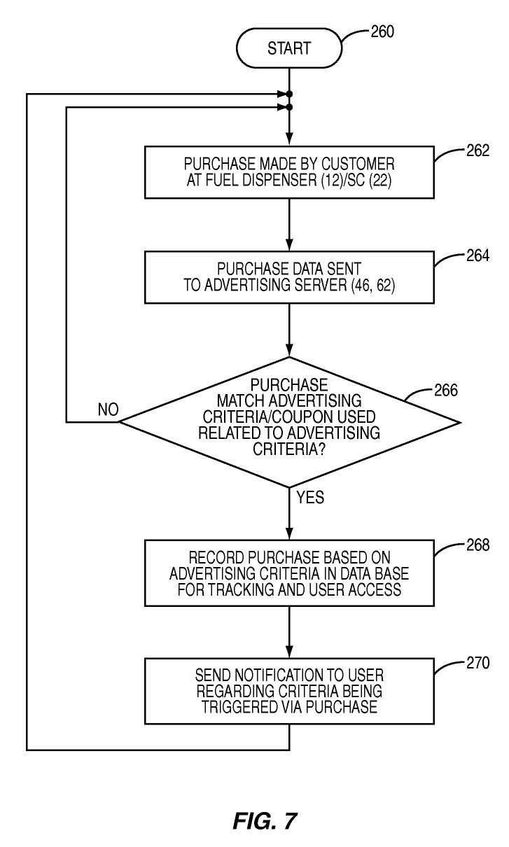

FIG. 7 illustrates a basic flow chart diagram related to a tracking system so that the effectiveness of an advertising campaign may be tracked since such may affect billing. The process starts (step 260), and a purchase is made by the customer at the fuel dispenser 12 or site controller 22 of the service station 10 (step 262). The purchase data is then sent to the advertising server 46, 62 (step 264). The advertising server 46, 62 determines if the purchase matches any advertising criteria or coupon used related to the advertisement criteria configured to be displayed at the service station 10 (decision 266). If not, it is determined by the advertising servers 46, 62 that there is no correlation between the purchase made and the advertising content, and the system continues to repeat. If however, there is a match between the advertising criteria or the coupon used related to advertising criteria in a purchase, the advertising server 46, 62 records the purchase based on the advertising criteria in a database for tracking and user access. Thereafter, the advertising server 46, 62 may send a notification to the user regarding the criteria being triggered via customer purchase.

Those skilled in the art will recognize improvements and modifications to the preferred embodiments of the present invention. All such improvements and modifications are considered within the scope of the concepts disclosed herein and the claims that follow.

What is claimed is:

1. A service station advertising display system, comprising:
a fuel dispenser having a user interface; and
a control system coupled to the fuel dispenser to control the user interface;
wherein the control system causes the fuel dispenser to display advertising on the user interface according to a purchase and bid system uploaded to the control system from a remote system.
